(19) United States
(12) Patent Application Publication
(10) Pub. No.: US 2011/0125748 A1
(43) Pub. Date: May 26, 2011

(54) Method and Apparatus for Real Time Identification and Recording of Artifacts

(75) Inventors: Matthew S. Wood, Salt Lake City, UT (US); Joseph H. Levy, Eagle Mountain, UT (US); Paal Tveit, Salt Lake City, UT (US)

(73) Assignee: Solera Networks, Inc., South Jordan, UT (US)

(21) Appl. No.: 12/946,539

(22) Filed: Nov. 15, 2010

Related U.S. Application Data
(60) Provisional application No. 61/261,365, filed on Nov. 15, 2009.

(51) Int. Cl. G06F 17/30

(52) U.S. Cl. 707/737; 707/741; 707/E17.046; 707/E17.002

(57) ABSTRACT

Methods and a system of method and apparatus for real time identification and recording of artifacts are disclosed. In one embodiment, a method of network database maintenance includes designating a network packet data to be stored in one of a packet capture repository and a file system resident database to indicate an artifact type, a protocol type, an application, a user-definable attribute, and a temporal session duration based on a real-time packet inspection. The method includes grouping the designated packet data in a database including packet data having a similar one of the artifact type, the protocol type, the application, the user-definable attribute and the temporal session duration. In addition, the method of network database maintenance includes indexing the database to point to a memory location of the designated packet data grouped in the database in the packet capture repository.

### RELATED APPLICATIONS

The application claims priority under 35 U.S.C. §119(e) to U.S. Provisional Application Ser. No. 61/261,365, Nov. 15, 2009. which is herein incorporated by reference in its entirety, and in particular to method and apparatus for real time identification and recording of artifacts.

### FIELD OF TECHNOLOGY

This disclosure relates generally to a technical field of software, hardware and/or networking technology, and in particular to method and apparatus for real time identification and recording of artifacts.

### BACKGROUND

The field of deep packet inspection involves, among other things, various different possible methods of discovering and analyzing the contents of packetized data being transmitted over a network. Identifying particular forms of data, e.g., a motion pictures experts group (MPEG) file, a voice over Internet protocol (VoIP) session, etc., as well as the content of a particular form of data, .e.g., the actual audio file encoded pursuant to the MPEG standard, the audio related to the VoIP session, etc., being transmitted over a network can be a time consuming and computationally intensive task given the rate and volume of packets possibly being transmitted over a network. If packets are recorded for subsequent examination or searching, as is practiced in network metric, security, and forensic applications, then identifying a particular form of data and extracting the contents of the data may involve first searching an entire database of packets, possibly 10s, 100s, or more terabytes of data, to identify any data possibly conforming to the search request. Such a search may simply not be conducive to practical, real time discovery and analysis of types and contents of interest.

### SUMMARY

Methods and a system to method and apparatus for real time identification and recording of artifacts are disclosed. In one aspect, a method of network database maintenance includes designating a network packet data to be stored in one of a packet capture repository and a file system to indicate an artifact type, a protocol type, an application, a user-definable attribute, and a temporal session duration based on a real-time packet inspection. The method includes grouping the designated packet data in a database including packet data having a similar one of the artifact type, the protocol type, the application, the user-definable attribute, and the temporal session duration. In addition, the method of network database maintenance includes indexing the database to point to a memory location of the designated packet data grouped in the database in one of the packet capture repository and the file system.

In another aspect, a method of network database maintenance includes identifying a flow of packet data to be stored in one of a packet capture repository and a file system based on a threshold window to indicate an artifact type, a protocol type, an application, an user-definable attribute and a temporal session duration upon a real-time packet inspection. The method of network database maintenance also includes recording a requisite packet data in the identified flow in a database including packet data having a similar one of the artifact type, the protocol type, the application, the user-definable attribute, and the temporal session duration when the threshold window is not exceeded. Further, the method also includes indexing the database to point to a memory location of the recorded requisite packet data in one of the packet capture repository and the file system.

In yet another aspect, a system includes one of a packet capture repository and a file system to store a network packet data, an index module to maintain a database including a designated network packet data to point to a memory location of the designated network packet data in one of the packet capture repository and the file system. The designated network packet data is grouped in the database in accordance with an artifact type, a protocol type, an application, an user-definable attribute, and a temporal session duration based on a real-time packet inspection along with packet data having a similar one of the artifact type, the protocol type, the application, the user-definable attribute, and the temporal session duration.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a process flow that illustrates designating a packet data and grouping the designated packet data in a database, according to one embodiment.

FIG. 2 is a diagrammatic view that illustrates storing of a packet data in a packet capture repository, according to one embodiment.

FIG. 3 is a schematic view illustrating the database indexing packets contained within the packet capture repository illustrated in FIG. 2, according to one embodiment.

FIG. 4 is a schematic view illustrating transmitting of data packets between a computer and a server, according to one embodiment. In an example embodiment,

FIG. 5 is a flow chart that illustrates a method of identification and recording of a packet data, according to one embodiment.

FIG. 6 is a diagrammatic view illustrating communication between an index module, an indexing database, and the indexing database's pointing to locations within the packet capture repository, according to one embodiment.

FIG. 7 is a system view of a network system illustrating storage and retrieval of packet data moving across the network, according to one embodiment.

Other features of the present embodiments will be apparent from the accompanying drawings and from the disclosure that follows.

### DETAILED DESCRIPTION

Methods and a system of method and apparatus for real time identification and recording of artifacts are disclosed. In the following description, for the purposes of explanation, numerous specific details are set forth in order to provide a thorough understanding of the various embodiments. It may be evident, however, to one skilled in the art that the various embodiments may be practiced without these specific details.

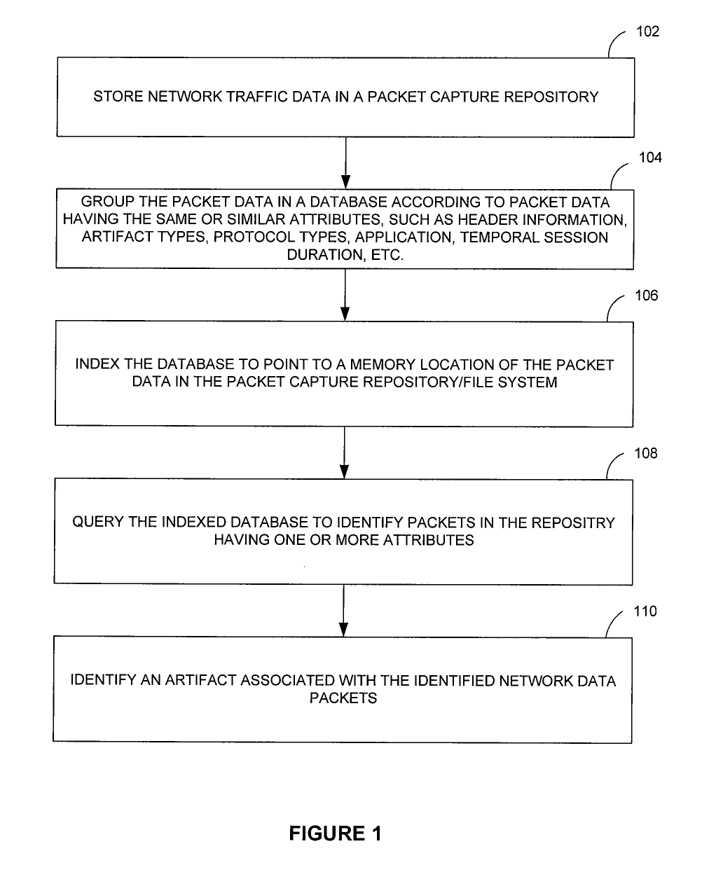

FIG. 1 is a process flow that illustrates designating a packet data and grouping the designated packet data in a database, according to one embodiment. To begin, network packet data crossing a network is stored in a packet capture repository 204 (operation 102). The packets stored in the repository may have a variety of possible attributes as well as may transmit all sorts of data content. Packet header attributes may include source and destination Ethernet addresses (e.g., media access control (MAC) addresses), source and destination Internet Protocol addresses (IPv4, IPv6), source and destination port (UDP, TCP traffic), packet length, virtual local area network (VLAN) identification, protocol type, and a host of other possible information provided in a header or other packet area. Artifacts, or interesting forms of data flowing over a network, including a word processing document, a spreadsheet document, multimedia content, a multimedia file, an e-mail, an instant messaging (IM) communication, a compressed file, an executable file, a web page, a presentation document, a program file, etc. The protocol type associated with the network packet data may include a hypertext transfer protocol (HTTP), a simple mail transfer protocol (SMTP), a remote procedure call (RPC) protocol, voice over internet protocol (VoIP), a peer to peer protocol, a file transfer protocol (FTP), a streaming media protocol, an instant messaging protocol, etc. The packets and data transmitted therewith may include any data independent of type and/or structure being transmitted in a network (e.g., Asynchronous Transfer Mode network, 3G network, 4G network, Ethernet, etc.).

The packet data moving across the network stored in the packet capture repository 204 is grouped and indexed in a database 302 (operations 104 and 106). In one example, header attributes, flow attributes, and content types are identified in the packets contemporaneously with storage in the packet capture repository, and the header attributes, flow attributes, and content types are stored in discrete database units or otherwise in an indexing database. Each discrete header attribute and content type is stored in a sequence matching that of the packet capture repository. Hence, the database units provide an index into the packet capture repository. In one example, the packet capture repository is formed from uniformly sized containers or “slots,” with some number of database units designated for each slot, the number of database units matching the number of attributes and content types identified or designated for the network packets. One method and system of storing packets in network slot or otherwise storing packets is described in published PCT application PCT/US2005/045566 titled “Method and Apparatus for Network Packet Capture Distributed Storage System,” (WO 2006/071560), which is hereby incorporated by reference herein. Database units, bitmaps, and other relevant information is discussed in further detail in U.S. application No. 61/261,363 filed on Nov. 15, 2009 titled “Method and Apparatus for Storing and Indexing High-Speed Network Traffic Data” under attorney docket number P200709.US.01, which is hereby incorporated by reference herein.

A database unit may be designated for protocol type storage, for example. As packets flow over the network and are stored in the packet capture repository, e.g., a slot, the header of each packet is monitored and the protocol type is identified by reference in a database unit designated for protocol information. Each protocol type recognized by the system is assigned a bit in the bitmap, and when a protocol type is identified in the unit, the appropriate bit is set. Hence, for example, when a TCP protocol packet is stored in a slot, the entirety of the packet is stored in the slot, while only the TCP protocol designation is stored in the unit. The protocol designation is indexed to the actual packet. Further, a bit in the bitmap corresponding to TCP protocol is set.

With a data architecture as introduced above, a more efficient query of the network packet data may be performed as compared to searching through all of the packet capture repository for some artifact (operation 108). For example, through the bitmaps, the presence of packet data of interest may be identified without searching some or all of the slots or some or all of the database units. For example, by identifying each bitmap with the relevant protocol bit set, it is possible to identify units and slots containing TCP protocol information and TCP protocol packets, respectively. Further, without searching the entirety of a given slot for TCP protocol packets, it is possible first to search the TCP database unit to identify the memory location of TCP packets stored in the packet capture repository.

Targeted packets and conversations may then be efficiently searched to extract artifacts (operation 110). TCP packets may be identified as set out above, and subsequently TCP flow reconstruction may be performed by identifying all related TCP packets of a conversation. Further based on header, content or other attributes, the total number of conversations may be further reduced. Through file and protocol inspection and identification, artifacts and protocols within conversations may then be identified. For example, a discrete number of conversations may be located for such purposes as detection or extraction. For example, a discrete number of conversations may be identified as conforming with various possible query parameters, and the entirety of all packets in the packet capture repository may be efficiently searched by way of the repository, unit, bitmap architecture discussed herein. A file or protocol reconstructor or “carver” may then be run against the discrete number of identified conversations to identify an artifact, e.g. a file carver run to identify a text document, an MPEG file, a VoIP stream, etc. Further granularity may be then be achieved by searching for some expression within the artifact, e.g., a specific word within the reconstructed text document, etc.

A database 302 may include a packet data that may have a similar artifact type (e.g., Microsoft Word document, digital photograph, etc.), protocol type (e.g., internet protocol, VoIP, etc), session (e.g., Google Maps™ session, a Skype™ session, a Salesforce.com™) user-definable attribute (e.g. a custom protocol, the value of a particular offset within a packet or a specific type-length-value (TLV) contained within a packet), and/or temporal session duration as an accounting of the size (i.e., number of bytes) or time scale of the session as that of a packet identified with some particular attribute first identified in the database unit or some other discrete packet or flow identified through other means.

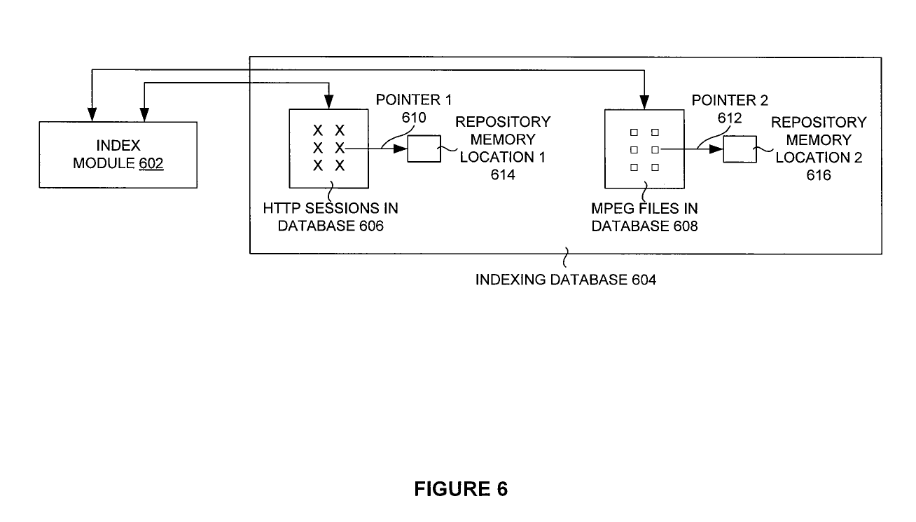

Referring again to FIG. 1, in operation 106, the database is indexed to point to a memory location of the designated packet data stored in a packet capture repository and/or a file system. Stated differently, and in one particular arrangement, there are one or more database units corresponding with a discrete fixed size slot, e.g., 64 MB, and the database units contain discrete attributes of network packets, e.g., packet header, flow, or content information, indexed to the complete packets stored in the slots. Indexing of a database may provide quick retrieval of information (e.g., data, packet data, etc.). In addition, indexing results in less memory consumption by storing only the key fields instead of the detailed information. The indexing of a database may be performed using an index module 602 of FIG. 6.

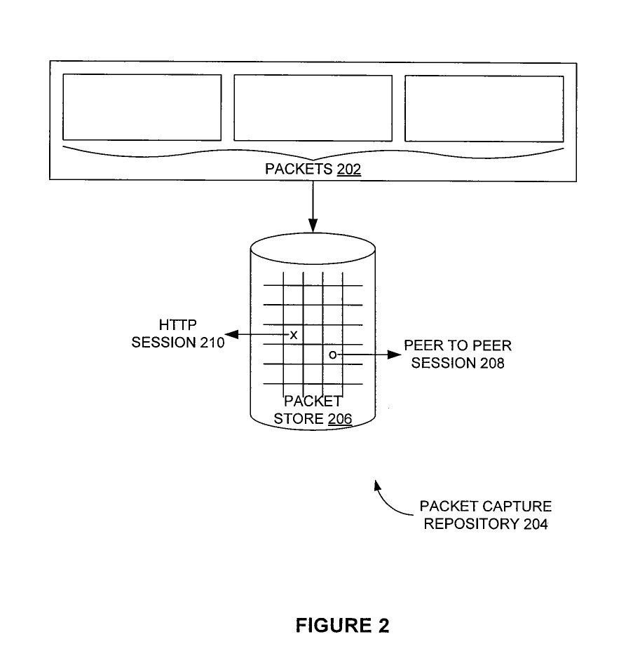

FIG. 2 is a diagrammatic view that illustrates storing of packet data in a packet capture repository, according to one embodiment. According to one embodiment, packet data may be identified in a flow of packets 202 crossing the network and the identified packet data may be stored in the packet capture repository 204. In one particular implementation, all packets flowing through a particular point in a network, such as at the location of a network tap, are stored in the packet capture repository. Practically speaking, some packets may be lost or dropped due to various issues including delivery failure or practical limits of computing technology, but the system attempts to capture every packet. The packets 202 may include a data unit (e.g., packets of data of an email, an instant message communication, an audio file, a compressed file, etc.) that may be carried by a flow of the packets in the network.

The packet capture repository 204 may include a packet store 206 containing a collection of packets whose contents might fall into a variety of classes such as a peer-to-peer session 208, an HTTP session 210 and other data as illustrated in FIG. 2. The HTTP session 210 may be a session that provides information associated with a client and a server. The HTTP session may provide a track of user's activity with a web server. In an example embodiment, the packets contained within the packet store 206 may include an artifact type, an application, a protocol type, a user-definable attribute, and/or temporal session duration. In another example embodiment, the artifact type may include a multimedia file, an e-mail, an instant messaging communication data, a compressed file, an executable file, a web page, a document file, an image file, etc. In yet another example embodiment, the protocol type may include HTTP protocol, a SMTP protocol, a FTP protocol, a peer to peer protocol, an instant messaging protocol, a Real-time Transport protocol (RTP), a Remote procedure call (RPC), a streaming media protocol, etc.

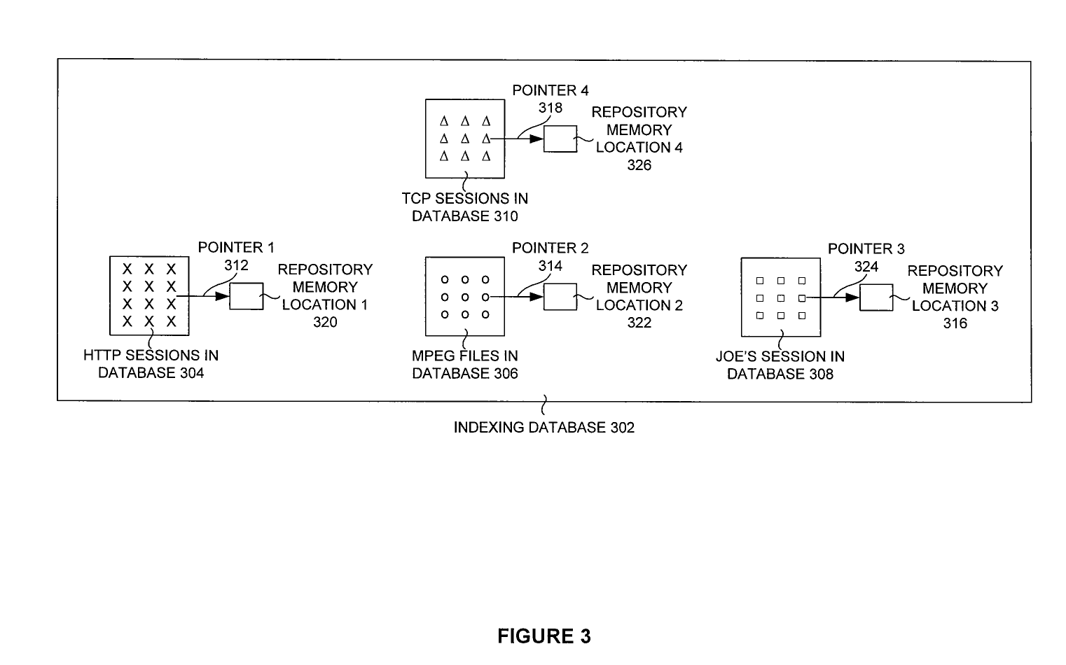

FIG. 3 is a diagram of the database indexing the contents of the capture repository illustrated in FIG. 2, according to one embodiment. The database 302 may be a collection of meta-data that is stored in an organized manner so that the data packets may be accessed efficiently through a query. The information (e.g., packet data, meta-data, etc.) may be extracted from the database 302 through a suitable database query. The database query may be performed through any number of interfaces including a graphical user interface, a web services request, a programmatic request, a structured query language (SQL), etc., used to extract related information of a packet data or any meta-data stored in the database 302. If a queried packet data/information is matched with the data stored in the database 302, then matched packets may be retrieved from the packet store 206 for reconstruction. The matched packet data may be reconstructed by referring to a memory location corresponding to designated packet data (e.g., as illustrated in FIG. 3).

An indexing database 302 may point to members of a collection of data packets according to “class,” where class may include any data such as attributes of a packet header, the presence of a multi media file flowing across the network, a session of a particular user of the network at a particular point in time, etc. The pointers may point to the memory location of packets stored in the packet capture repository 204 for the purpose of efficient retrieval of relevant packets.

The indexing database 302 may point to packets according to their having been classified as containing applications, files, and other data shared through the network in the native packetized format in which it was transmitted. Also, the sessions of each individual user in the network may be stored in the indexing database 302. Sessions may be grouped and stored in the database. For example, the indexing database may include HTTP sessions indexed in the database 304, TCP sessions indexed in database 310, MPEG indexed files in database 314, a particular user's session in database 308. Each database 304, 306, 308, 310 may be a database unit. In addition, the indexing database 302 may include pointers pointing to a memory location of particular information in a session. For example, a first pointer (1) 312 may point to memory location (1) 320 within the packet capture repository to represent the contents stored in a particular location of a HTTP session in the database 304. A second pointer 318 may point to a memory location (4) 326 within the packet capture repository to represent a TCP session in the database 310. A third pointer (3) 316 may point to a memory location (3) 324 within the packet capture repository to represent a content of a particular user's session in database 308 and a fourth pointer 314 may point to a memory location (2) 322 within the packet capture repository to represent a MPEG file stored in a particular location of database 306 as illustrated in FIG. 3.

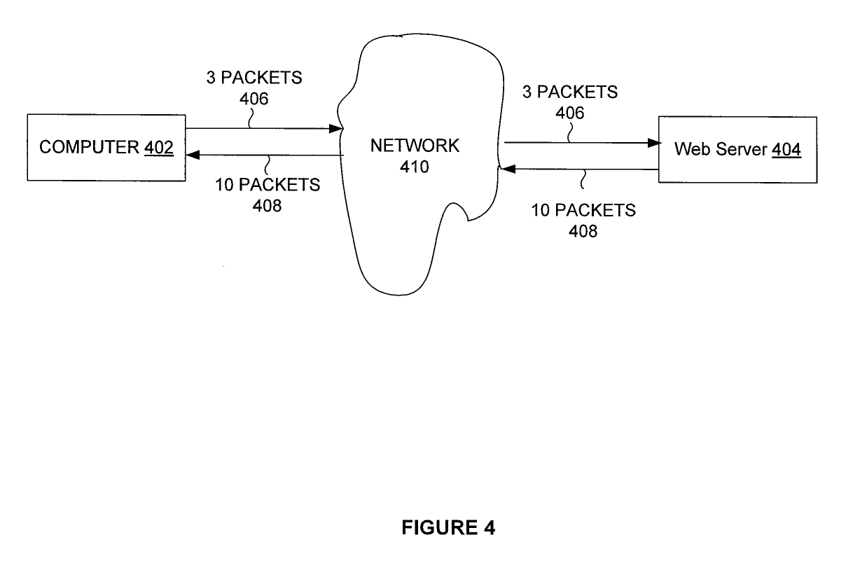

FIG. 4 is a schematic view illustrating transmitting of data packets between a computer 402 and a server 404, according to one embodiment. In an example embodiment, a user of the computer 402 may transmit three (3) packets to the server 404 (e.g., a web server) and the server may transmit 10 packets to the computer 402 based on the requests submitted by the user through the computer 402. The packets are transmitted between the computers over a networking system 410. The computer 402 may be a data processing device (e.g., personal computer, laptop, palmtop, mobile device, etc) that may communicate with the server 404 (e.g., a web sever, a database server, media server, etc) through a network. The server 404 may be device that provides some service to a user of the computer 402 based on the service requested by the user.

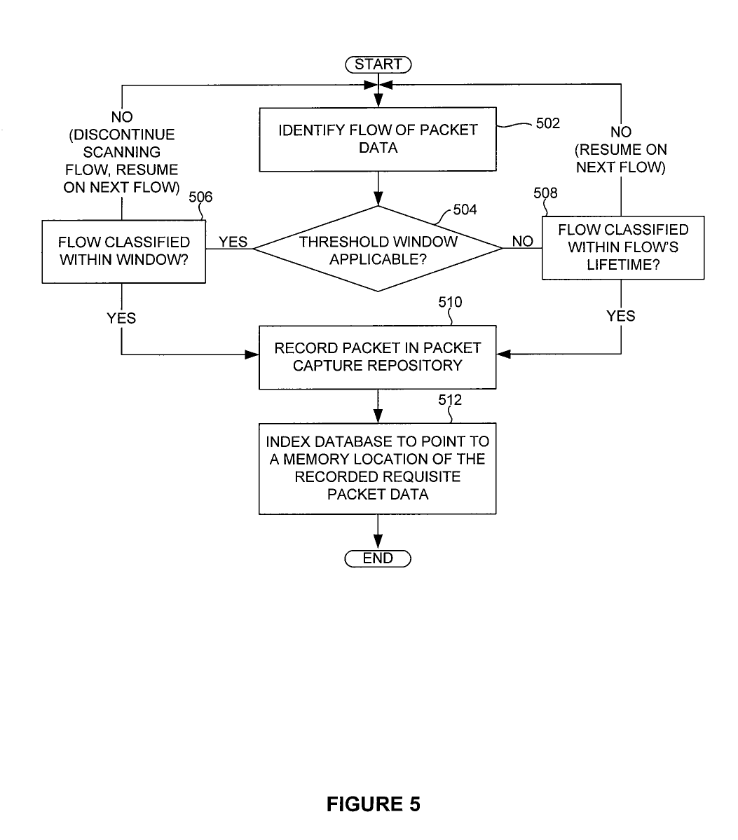

FIG. 5 is a flow chart that illustrates a method of identification and recording of a packet data, according to one embodiment. In operation 502, the classification (e.g., through deep packet inspection, header evaluation, etc.) of a flow of a packet data that is stored in a packet capture repository (e.g., the packet capture repository 204) may be done so within a threshold window. The use of a limiting threshold window 504 may be employed as an optimization of the classification procedure. Since deep packet inspection is a computationally intensive process, it may be desirable for the purpose of the conservation of computing resources to selectively exclude certain packets from inspection. Many packets flows can be classified within the first few packets of the flow, as is the case with HTTP, SMTP, many peer-to-peer and instant messaging protocols, VoIP sessions, etc. One embodiment of an exclusionary threshold window may thus be packets that are members of a flow that has previously been classified. Another embodiment of an exclusionary threshold window may be packets that are part of a flow that after a certain number of packets remains unclassified, and which by its nature (e.g., matching no known protocol, application or content classes) may be considered unclassifiable. The threshold window may be a value to identify a requisite packet within the specified value/range or packets or bytes within a flow. Further, the threshold window may be determined conditionally or heuristically, as would be desirable (in inclusionary fashion) when encountering compound flows such as HTTP which may first be classified as “type HTTP” but which, by its nature as a transport protocol, is likely to contain file or artifact types (such as a GIF image file, a JavaScript source file, or a Shockwave Flash (SWF) file, etc.) that might be further classified as “type GIG,” “type JavaScript,” or “type SWF.”

In operation 506, it is determined whether the identification of packet data exceeds, when determined application by operation 504, the threshold window value. If the packet data is not identified in the threshold window then, further scanning of the flow is discontinued.

In operation 510, the packet from the flow of packet data 202 may be recorded in the packet capture repository 204. The packet data may contain an artifact type, a protocol type, an application, an user-definable attribute, and/or a temporal session duration. In operation 512, the indexing database 302 may be updated (e.g., using the index module 602 of FIG. 6) to point to a memory location (e.g., memory location (1) 320, memory location (2) 322, etc, as illustrated in FIG. 3) of the recorded packet data. The database 302 may then be subsequently queried, as described herein, for quick and efficient retrieval of the required information such as an artifact type (e.g., a web page, an e-mail, a program file, multimedia file, etc.), a protocol type, an application, an user-definable attribute, a temporal session duration, etc.

FIG. 6 is a diagrammatic view illustrating communication between an index module, an indexing database, and the indexing database's pointing to locations within a packet capture repository 204, according to one embodiment. According to one embodiment, the data stored in an indexing database 604 is indexed to point to memory location of data (e.g., an HTTP session in database 606, MPEG files in database 608) using an indexing module 602. Indexing may provide optimized speed to access (e.g., find, locate) a data for a search query. In an example embodiment, indexing may also include a logical sequence of web pages, and/or multimedia files in the network (e.g., internet).

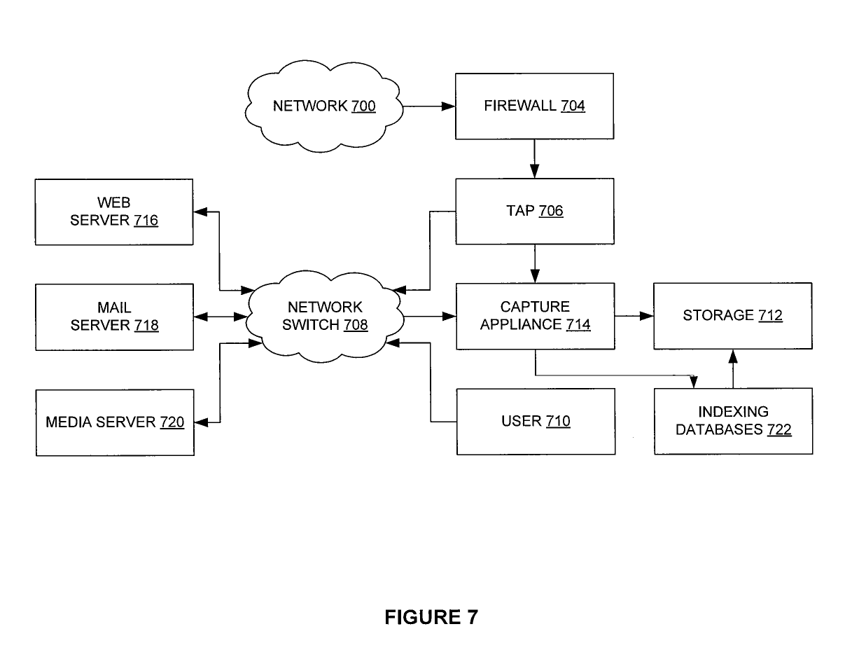

FIG. 7 is a system view of a network system illustrating storage and retrieval of packet data moving across the network, according to one embodiment. In one embodiment,

FIG. 7 illustrates a user 710 communicating to a web server 716, a mail server 718, and a media server 720 through a network 700. The network 700 may be provided with a firewall 704 to block an unauthorized access and allow an authorized access to the network data. A tap 706 may be a device used to monitor network traffic between two points in the network. A network switch 708 may be configured to perform tapping function that may capture network traffic (e.g., flow of packet data crossing the network). The network switch 700 may be a data switching device that may forward packet data from a source network component to a destination network component.

The network 700 may be communication system that may link one of a client computer, a server and other peripheral devices, and allow users to exchange messages and access resources on a storage device, server, etc. The packets of data flowing across the network in real-time may be captured by a capture appliance 714 and may be stored in storage 712. A network switch 708 may be a connecting device used to connect the other devices in the network. A user 710 may be a client who may transmit data (e.g., sending, receiving, etc.) to the servers (e.g., the web server 716, the web server 718, and/or the media server 720) and the other clients of the network 700 through the server.

The storage 712 may be a repository that may store data (e.g., packets). An indexing database 722 may contain records of a variety of classes of data with pointers to instances of those classes of data within the repository. A web server 716 may be a server that may provide web pages/HTML pages to a client in the network 700. The mail server 718 may transfer electronic mail messages from one client device to the other client device in the network 700. The media server 720 may store and share the media files with the clients in the network 700.

According to one embodiment, every single packet moving across the network in real-time may be captured by a capture appliance 714 and stored in the storage 712. The storage 712 may be a nonvolatile memory, a RAID, a local storage device, or any other storage location. The data packets may be identified in a flow of packets before storing into the storage 712 and/or after extracting the data (e.g., packets, etc.) from the storage 712. The flow of the packet data may be identified through a packet source identification data and/or a packet destination identification data. In an example embodiment, the identification of a designated data may be performed on a high speed network having 10 Gbps network traffic. Also, the identification of flow of packet data may also be based on a threshold window value which may be arrived at heuristically and when a match is obtained for the requisite packet data, the requisite packet data may be recorded in the indexing database 722. The method and identification of packet data based on the threshold value may be as illustrated in FIG. 5.

The packets moving into the storage 712 may be filtered based on a artifact type, a protocol type, and/or combination of both the types. When the packets are moving into the storage 712, they are stored on the temporary memory where they are quickly analyzed and grouped (“classified”) and their meta information, e.g., header information, is recorded in the indexing database 722 (e.g., database units). There may be multiple databases for various classes of artifact type, applications, user-definable attribute, and/or protocol type as illustrated in FIG. 3. Then, the packets may be stored in the storage device (e.g., the storage 712) and the pointers pointing to the memory location of these packets may be stored in the database 722.

A query may be executed to extract a packet data, meta-data, or any content of the packet data (e.g., a media file, a document file, etc.) from the database. The data may be extracted to perform data analytics, data forensics, data metrics, etc. For example, the data metrics may include the number of instant messaging sessions of a particular user at a particular interval of time, the number of HTTP sessions of a particular user in the last month, etc.

In one embodiment, one or more pattern matching techniques may be employed to extract the matched using packet data in the database. Furthermore, the pattern matching technique may operate through a fuzzy pattern matching, regular expression, and/or scanning through the data in a database. The matched packet data may be reconstructed based on the memory location of the requisite packet data. Reconstruction of the matched packet data may integrate information associated with the matched packet data in a suitable format. At the end of the reconstruction process, the integrated information may be presented in accordance to a convenient format and rendered on a web browser, or by another applicable file or content viewer. The presented information may include temporally ordered list consisting of a thumbnail image.

In another embodiment, an image of an element of the temporally ordered list may be reconstructed using a virtual client application and/or a virtual web browser. Finally, a file associated with a matched packed data may be rendered on a client application. The extracted file (e.g., a word processing document, a spreadsheet document, a database, an image, a video, a multimedia file, an email, an instant message communication and/or an audio file) may be used to perform network visibility analysis of users on data files flowing across the network 700.

Although the present embodiments have been described with reference to specific example embodiments, it will be evident that various modifications and/or changes may be made to these embodiments without departing from the broader spirit and/or scope of the various embodiments. For example, a combination of software and/or hardware may be used to enable the viral growth extension through recommendation optimization in online communities disclosed herein to further optimize function.

It will be appreciated that the various operations, processes, and methods disclosed herein may be embodied in a machine-readable medium and/or a machine accessible medium compatible with a data processing system (e.g., a computer system), and may be performed in any order.

The structures and/or modules in the figures are shown as distinct and communicating with only a few specific structures and not others. The structures may be merged with each other, may perform overlapping functions, and may communicate with other structures not shown to be connected in the Figures. Accordingly, the specification and drawings are to be regarded in an illustrative rather than a restrictive sense.

What is claimed is:

1. A method of network database maintenance comprising:
designating a network packet data to be stored in one of a packet capture repository and a database residing on a file system to indicate at least one of an artifact type, a protocol type, an application, and a temporal session duration based on content analysis and inspection;
grouping the designated packet data in the database, the groupings comprising packet data having a similar at least one of the artifact type, the protocol type, the application, and the temporal session duration;
indexing the database to point to a memory location of the designated packet data in the packet capture repository; and
providing for querying the indexed database to identify a location of packet data in the packet capture repository.

2. The method of claim 1, further comprising recording a metadata in the database, the metadata associated with the designated packet data in the database.

3. The method of claim 1, wherein the artifact type comprises at least one of a word processing document, a spreadsheet document, a database, a multimedia content, a multimedia file, an e-mail, an instant messaging (IM) communication, a compressed file, an executable file, a web page, a presentation document, a program file, and a data package.

4. The method of claim 1, wherein the protocol type comprises at least one of a hypertext transfer protocol (http), a simple mail transfer protocol (SMTP), a remote procedure call (RPC) protocol, voice over internet protocol (VoIP), a peer to peer protocol, a file transfer protocol (ftp), a streaming media protocol, and an IM protocol.

5. The method of claim 1, further comprising reconstructing the identified packet data based on the location of a corresponding designated packet data in the packet capture repository.

6. The method of claim 1, further comprising performing at least one of data analytics, data statistics, data forensics, and data metrics based on the identified packet data in the database.

7. The method of claim 1, further comprising querying the database to apply a pattern matching scheme to extract the identified packet data from the packet capture repository.

8. The method of claim 5, wherein reconstructing the identified packet data includes presenting information associated with the identified packet data in a suitable format to convenient analysis of the presented information.

9. The method of claim 5, wherein reconstructing the identified packet data includes a sequencing process to correctly order and normalize a packet flow.

10. The method of claim 7, wherein the pattern matching scheme includes at least one of scanning, regular expression, and fuzzy pattern matching.

11. The method of claim 7, further comprising identifying a flow of the packet data prior to applying the pattern matching scheme.

12. The method of claim 8, wherein the presented information associated with the identified packet data includes at least one of a temporally ordered list comprising at least one element represented by at least one of a thumbnail image and an informational description.

13. The method of claim 5, wherein reconstructing the identified packet data further includes rendering information associated with the matched packet data on a web browser.

14. The method of claim 11, further comprising identifying the flow of the packet data through a packet source identification data and a packet destination identification data.

15. The method of claim 12, further comprising rendering a file associated with the matched packet data on a client application.

16. The method of claim 12, further comprising:
reconstructing an image associated with the at least one element of the temporally ordered list using a virtual client application; and
forming the thumbnail image through a snapshot of the image associated with the at least one element of the temporally ordered list.

17. The method of claim 16, further comprising reconstructing the image associated with the at least one element of the temporally ordered list using a virtual web browser.

18. A method of network database maintenance comprising:
applying a threshold window to identify a flow of packet data to be stored in one of a packet capture repository and a file system resident indexing database to indicate at least one of an artifact type, a protocol type, an application, and a temporal session duration upon a real-time packet inspection;
recording a packet data in the identified flow in a database comprising packet data having a similar at least one of the artifact type, the protocol type, the application, and the temporal session duration when the threshold window is not exceeded; and
indexing the database to point to a memory location of the recorded packet data in a packet capture repository.

19. The method of claim 18, further comprising querying the database facilitate the extraction of a matched packet data from the packet capture repository by determining its location from the packet data recorded in the database.

20. The method of claim 18, further comprising recording a metadata associated with the packet data in the database.

21. The method of claim 18, wherein the artifact type comprises at least one of a word processing document, a spreadsheet document, a database, a multimedia content, a multimedia file, an e-mail, an instant messaging (IM) communication, a compressed file, an executable file, a web page, a presentation document, a program file, and a data package.

22. The method of claim 18, wherein the protocol type comprises at least one of a hypertext transfer protocol (http), a simple mail transfer protocol (SMTP), a remote procedure call (RPC) protocol, voice over internet protocol (VoIP), a peer to peer protocol, a file transfer protocol (ftp), a streaming media protocol, and an IM protocol.

23. The method of claim 18, wherein the threshold window may be applied to an inspection and analysis of a packet flow.

24. The method of claim 23 wherein exceeding the threshold window causes a discontinuation of the inspection and analysis of the packet flow.

25. The method of claim 19, further comprising reconstructing the matched packet data based on a corresponding memory location of the recorded requisite packet data in the packet capture repository.

26. The method of claim 19, comprising querying the database to apply a pattern matching scheme to extract the matched packet data in the database.

27. A system comprising:
a packet capture repository to store a network packet data; and
an indexing database, maintained by an indexing module, containing classified data modules pointing to one or more memory locations of one or more network packet data in the packet capture repository, the network packet data being grouped in the database in accordance with at least one of an artifact type, a protocol type, an application, and a temporal session duration based on a real-time packet inspection along with packet data having a similar at least one of the artifact type, the protocol type, the application, and the temporal session duration.

28. The system of claim 27, wherein the network packet data is from one of an Asynchronous Transfer Mode (ATM) network, an Ethernet, a 3G network, a 4G network, and a wireless network.
